(19) United States
(12) Patent Application Publication
(10) Pub. No.: US 2013/0317912 A1
(43) Pub. Date: Nov. 28, 2013

(54) Advertising in Augmented Reality Based on Social Networking

(71) Applicant: William Bittner, Brookfield, CT (US)

(72) Inventor: William Bittner, Brookfield, CT (US)

(21) Appl. No.: 13/891,034

(22) Filed: May 9, 2013

Related U.S. Application Data
(60) Provisional application No. 61/644,573, filed on May 9, 2012.

(51) Int. Cl. G06Q 30/02; G06T 19/00

(52) U.S. Cl. CPC G06Q 30/0267; G06T 19/006
USPC 705/14.64; 345/633

(57) ABSTRACT

A system and method for advertising in augmented reality to a user uses an augmented reality device and a processing device in communication with the augmented reality device. The processing device is also adapted to communicate with a network. Media scrape and advertising databases are in communication with the processing device. The advertising database stores advertising data. The processing device contains software or is programmed to receive an image from the augmented reality device, scrape social media data relating to the user stored on the network, store the scraped social media data on the media serape database, compare the image to the scraped social media data to determine if there is a connection between the user and the image, compare the image to the advertising data to determine if there is a connection between the user and the image, generate an advertisement using advertising data corresponding to the image and transmit the advertisement to the augmented reality device for viewing by the user.

### CLAIM OF PRIORITY

This application claims priority to U.S. Provisional Patent Application Ser. No. 61/644,573, filed May 9, 2012, the contents of which are hereby incorporated by reference,

### FIELD OF THE INVENTION

The present invention relates generally to augmented reality devices and systems and, in particular, to an advertising system and method for such devices and systems.

### BACKGROUND

Augmented reality provides a user with a live view of a physical, real-world environment, augmented with artificial computer-generated sound, video and/or graphic information A device typically displays the live view of the physical, real-world environment on a screen or the like, and the artificial, computer-generated information is overlaid on the user's live view of the physical, real-world environment. This is in contrast with vitrual reality, where a simulated environment entirely replaces environment.

Augmented reality is beginning to be incorporated into and used on smart phones and other personal display devices, using GPS and other technology. Furthermore, personal display devices that are especially suited to implement augmented reality technology, such as eyeglasses (GOOGLE GLASS), head-mounted displays and even contact lens and virtual retinal displays, are being developed.

Augmented reality provides a tremendous opportunity for businesses to advertise to individuals using the technology. A need exists for a system and method that provides advertisements to a user that target the user's interests and environment. In addition, it would be desirable for such a system and method to use information mined from social networking websites to generate advertising for use as overlays in augmented reality. Furthermore, it would be desirable for such a system and method to target the advertising based on a user's real-time location and view.

### BRIEF DESCRIPTION OF THE DRAWINGS

FIG. 1 is a block diagram an embodiment of the augmented reality advertising system of the invention;

FIG. 2 is a flowchart illustrating an embodiment of the augmented reality advertising method of the present invention as performed by the system of FIG. 1;

FIGS. 3A and 3B are flowcharts illustrating the calculation of the location and viewing angle in an embodiment of the method of FIG. 2;

FIG. 4 is a block diagram illustrating an embodiment of the architecture of the server of the augmented reality advertising system of FIG. 1;

FIG. 5 is an illustration of a display viewed by a user in an embodiment of the system and method of the invention.

### DETAILED DESCRIPTION OF EMBODIMENTS

Embodiments of the invention use information available from a user's social networking and the augmented reality viewed by the user to create targeted advertisements and further overlay such advertisements on top of the user's viewed augmented reality.

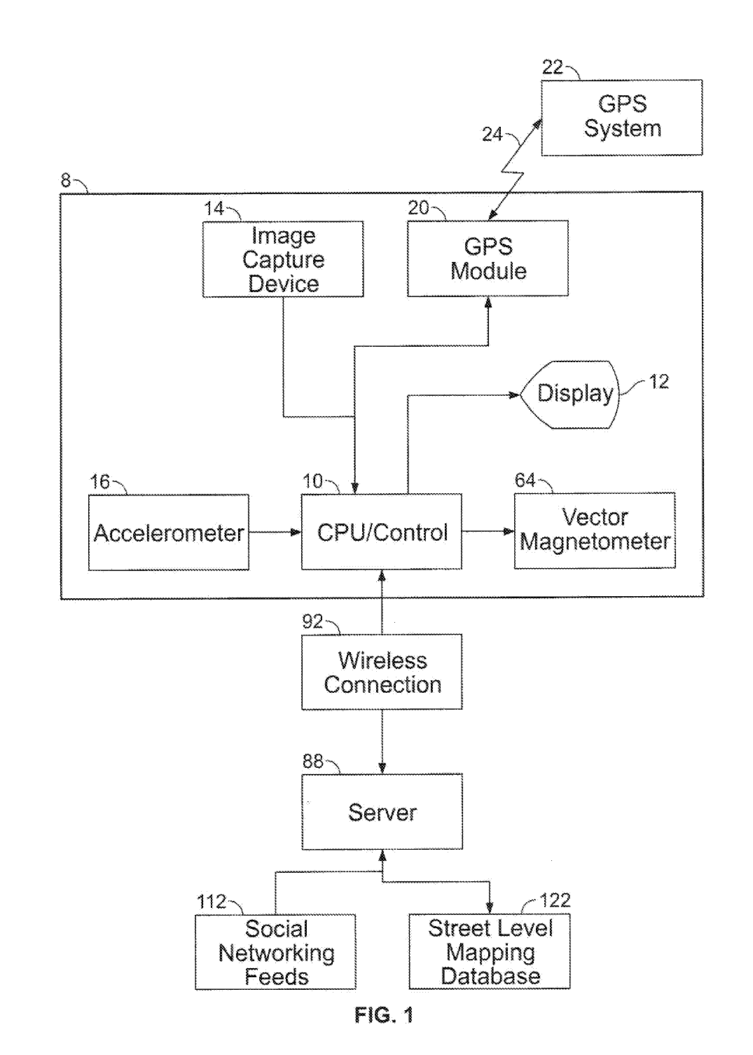

An embodiment of the system of the present invention is illustrated in FIG. 1. As illustrated in FIG. 1, the system includes an augmented reality display device 8, which may be any device capable of creating an augmented reality for a user to view. For example, such a device may be, but is not limited to, a computer display, smart phone, head-mounted display or GOOGLE GLASS device. A further example is provided in U.S. Patent Application Publication No. US 2010/0164990 A1. U.S. patent application Ser. No. 12/063,145 to Van Doom, the contents of which are hereby incorporated by reference. The augmented reality device includes a central processing unit (CPU), microcontroller or similar central processing or controller device or circuitry 10.

The augmented reality device 8 includes a display 12 and an image capture device 14 (such as a camera, sensor or the like). The image capture device, as the name implies, “views” images and transmits them to the display via the CPU 10 to provide the user with a real-time view of the user's physical, real-world environment. In addition, the augmented reality display device is capable of receiving and displaying information, that is generated in accordance with embodiments of the invention as described below, and overlaying it on the user's live view of the physical, real-world environment.

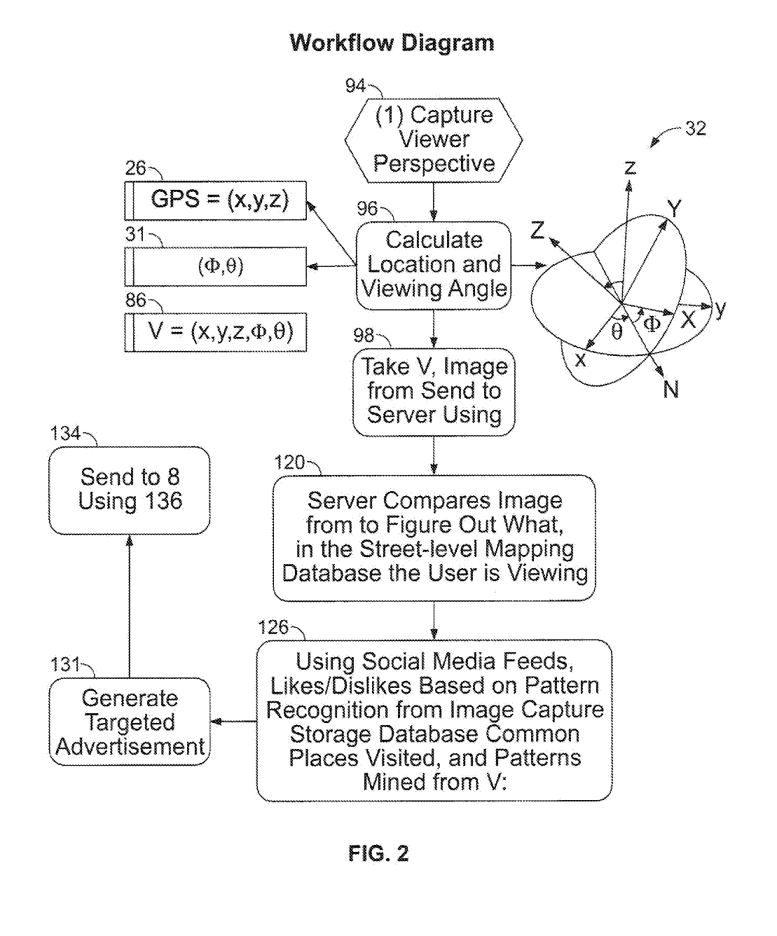

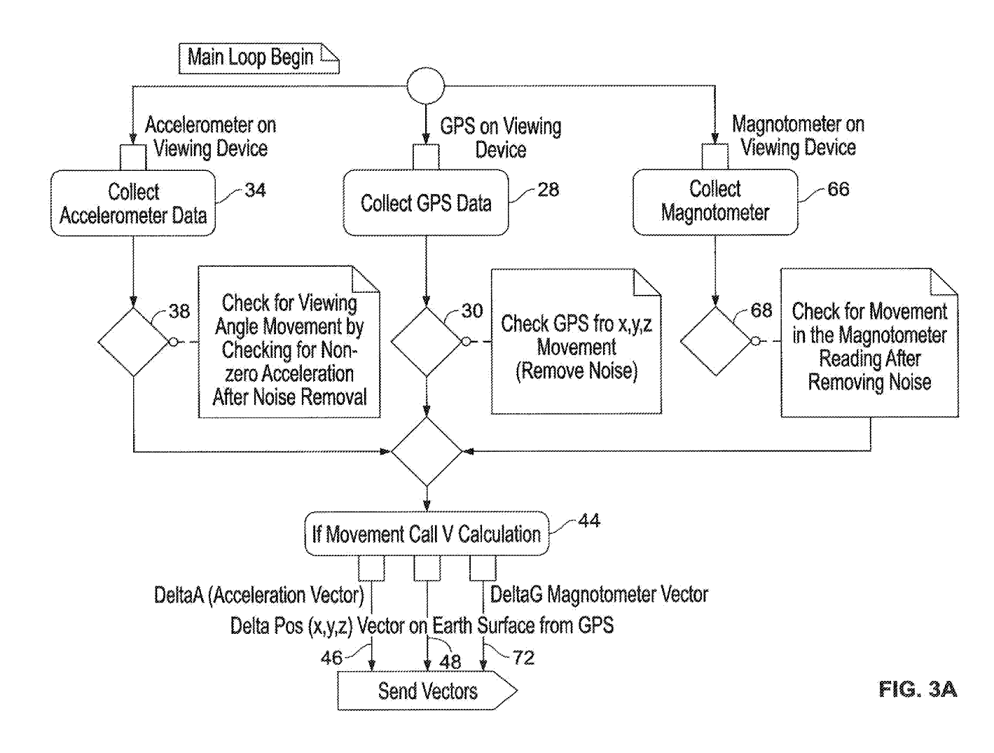

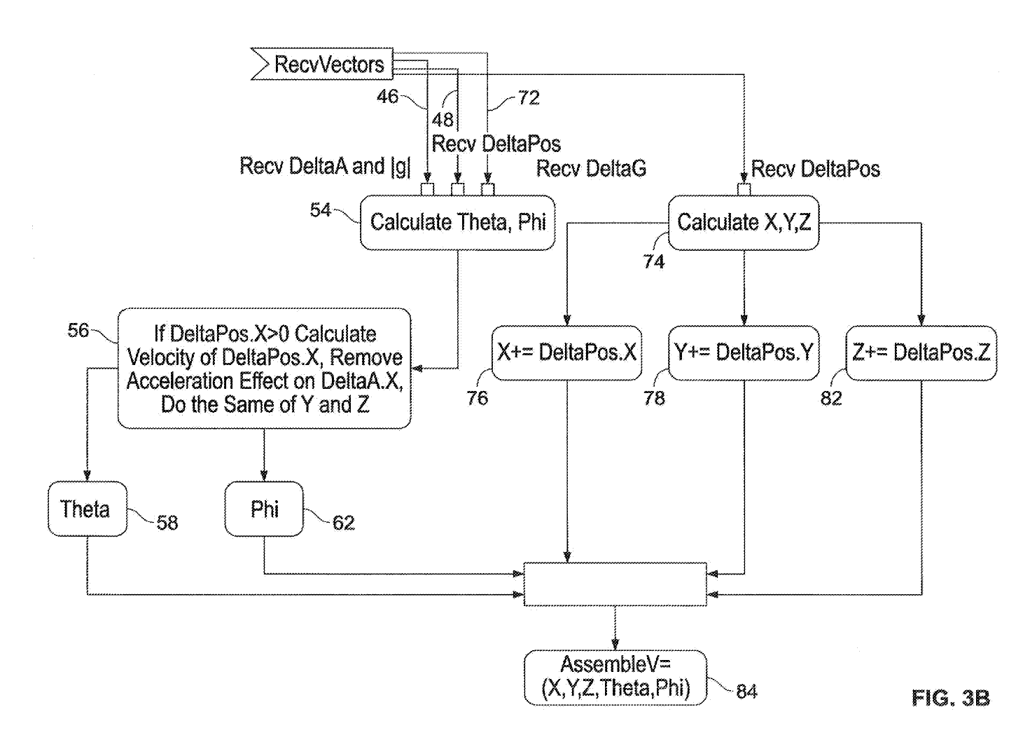

The augmented reality device is also preferably provided with an accelerometer device 16 and a GPS module 20 that communicate with CPU 10. These components are used to calculate the coordinates of a vector (V) representing user's view for use by the system in determining what a user is viewing through the image capture device 14 and display 12. The use of these components in calculating vector V will now be explained with reference to FIGS. 2, 3A and 3B.

As illustrated in FIG. 1. The GPS module 20 of the augmented reality device 8 communicates with a GPS system 22 via wireless communications link 24. Such GPS systems are well known in the art. As illustrated at block 26 of FIG. 2, the GPS system and module determines the user's location in terms of global position coordinates x, y and z. As indicated by block 28 of FIG. 3A, this information is provided to the augmented reality device CPU 10 (FIG. 1). As indicated at 30 in FIG. 3A, any movement of the user is also tracked by the GPS system and module and provided to the augmented reality device CPU.

As indicated at 31 and 32 in FIG. 2, in addition to knowing the location (x, y, z) of the user via the GPS system and module, the system needs to track the movement of the augmented reality image capture device (14 of FIG. 1) in terms of the viewing, angles theta (θ) and phi (φ) to determine what the user is viewing via the device display (12 of FIG. 1). The direction of viewing by the image capture device is illustrated as the angle theta (θ) and phi (φ) relative to the initial or previous viewing vector represented by N in FIG. 2 (at 32). With reference to FIG. 1, this may be accomplished via the accelerometer 16. More specifically, as illustrated in FIG. 3A, the CPU of the augmented reality device receives data from the accelerometer at 34. As a result, the CPU checks for viewing angle movement by checking tier non-zero accelerometer signals at 38.

As indicated at 44 in FIG. 3A, any movement detected by the accelerometer or GPS results in the CPU calling the V calculation subroutine. An acceleration vector (DeltaA) 46 and GPS position vector (DeltaPos) 48 are used to calculate view angles theta and phi (32 of FIG. 2) as indicated at block 54 of FIG. 3B. As indicated by block 56 of FIG. 3B, the subroutine first removes the components of the UPS position vector in the x, y and z directions (DeltaPosX. DeltaPosY, DeltaPosZ) after calculating the velocity of DeltaPosX, DeltaPosY and DeltaPosZ so that they do not interfere with the accelerometer readings in the x, y and z directions (DeltaA.X, DeltaA.Y, DeltaA.Z). Next as indicated at blocks 58 and 62, theta and phi are calculated using the a sin function in the equations:

Theta=a sin (DeltaA.y/|g|)

Phi=a sin (−DeltaA.X/(|g|*cos (a sin (DeltaA.Y/|g|)))

Where |g| is the gravitational field vector from the accelerometer (as is typically provided by accelerometer devices).

As illustrated in FIG. 1, the augmented reality device may optionally or alternatively include a vector magnetometer 64 as a redundancy or so as to serve as a back-up for the accelerometer 16. As illustrated in FIGS. 3A and 3B, the CPU of the augmented reality device receives data from the magnetometer at 66. As a result, the CPU checks (hr viewing angle movement by checking for movement in the magnetometer at 68. As indicated at 44 in FIG. 3A, any movement detected by the magnetometer results in the CPU caning the V calculation subroutine. A magnetometer acceleration vector (DeltaG) 72 and position vector 48 (from the GPS) are used to calculate view angles theta and phi (32 of FIG. 2) as indicated at block 54 of FIG. 3B. As yet another option or alternative for determining the viewing angle of the image capture device (and thus the user), prior art GPS systems often include a “heading” feature which can determine the direction of the device incorporating the GPS system. As a result, embodiments of the system could optionally or alternatively use the heading feature of the GPS system to determine the initial viewing angle theta.

As indicated at 74 in FIG. 3B, the GPS position vector is used to determine the Correct current values for x, y and z, as indicated in blocks 76, 78 and 82 using the equations:

x+=DeltaPosX

y+=DeltaPosY

z+=DeltaPosZ

More specifically, x, y and z remain the same if they already equal DeltaPosX, DeltaPosY and/or DeltaPos Z, or, if not, the values of DeltaPosX, DeltaPosY and/or DeltaPosZ are added to x, y and/or z.

As indicated at block 84 of FIG. 3B, and block 86 of FIG. 2, the values determined for x, y, z, theta and phi are assembled to form vector V.

Additional information and optional additional features relating to the calculation of the vector V (or point of interest/POI) may be found in U.S. Patent Application Publication No. US 2013/0046461 A1, U.S. patent application Ser. No. 13/213,492 to Balloga, the contents of which are hereby incorporated by reference.

As indicated in FIG. 1, the augmented reality device communicates with a processing device, such as server 88, via a network connection 92, such as a wireless Internet connection. As an alternative to the Internet, the network could be a private network or a private/public network. The augmented reality device 8 may communicate with the server 88 using an alternative type of wireless connection for any other type of connection). The server includes a processor or microprocessor and memory storage. The software for performing the functions described below is loaded onto the server as are the databases that store the data entered into and processed by the software. In alternative embodiments, the various databases described below may be stored on one or more computer devices separate from the server 88.

As illustrated in FIG. 2, the location and viewing angle calculated at 94 in the form of vector V and the view received by the user via the image capture device at 96 are passed to the server at 98.

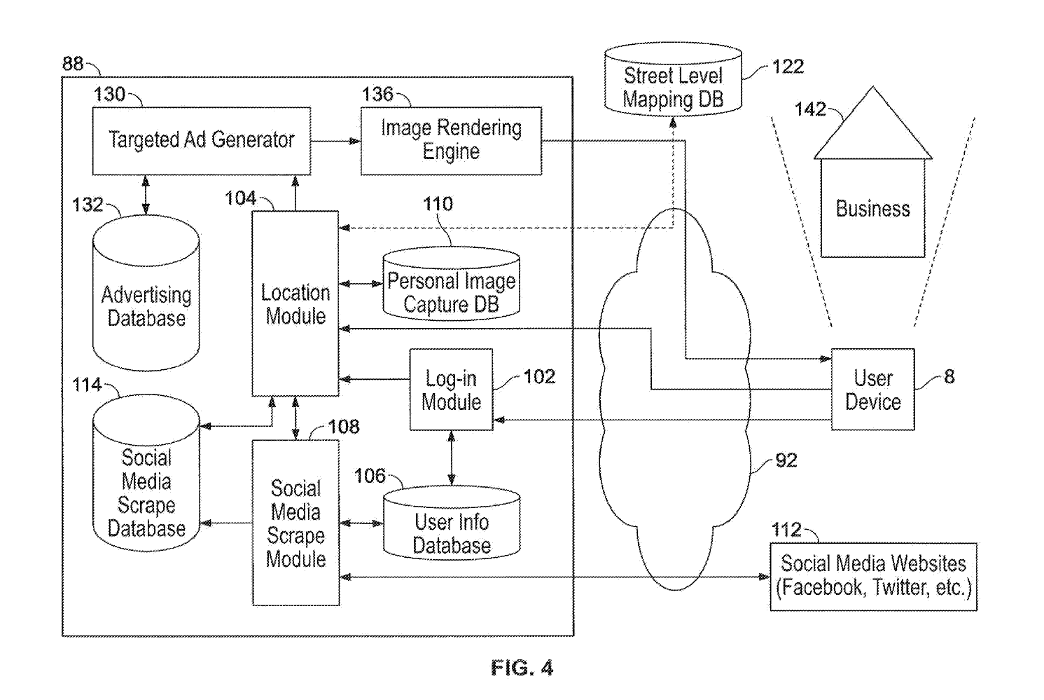

As illustrated in FIG. 4, the server 88 includes a log-in module 102, which enables the user to log onto the system. Once the user logs in with his or her user name or password, which is transmitted from the user device, the data (vector V and images from the augmented reality device) are received by a location module 104 of the server. The user's username and password are stored on a user information database 106.

In addition, the user information database 106 includes information about the user, including, but not limited to, personal user data such as address, educational background, marital status, family information, pet information and the names of friends. This information may be entered by the user when he or she registers to use the system.

The server of FIG. 4 also includes a social media scrape module 108. In addition to the user's personal information and username and password for the server 88, the user information database 106 includes the user's usernames and passwords for all of the user's social media websites. These usernames and passwords are provided to a social media scrape module 108. The social media scrape module accesses social media websites 112 through network 92 and accesses the user's social media data after logging on to the social media websites using the user's social media website usernames and passwords. The social media scrape module 108 then scrapes the users social media data for information that may be relevant and of interests to businesses and advertisers. This information may include, but is not limited to:
a. Likes/dislikes
b. Mentions in posts
c. Captions in pictures
d. Comments in pictures
e. Pictures at location
f. Friends of friend's mentions
   The user's personal information stored on the user information database 106 may be used by the social media scrape module 108 to assist in identifying relevant data during the social media scraping (but use of the personal information is not mandatory).

Examples of the social media websites 112 include, but are not limited to, Facebook, Linkedin, MySpace, Pinterest, Tumblr, Twitter, Google+, DeviantArt, LiveJournal, Orkut, Flickr, Sina Weibo, Vkontakte, Renren, Douban, Yelp and Mixi, Qzone. As a result, data regarding the user's likes, interests, hobbies, travel preferences and the like is collected from the user's pages on the social media websites 112. Examples of the social media scrape techniques and systems that may be used by social media scrape module 108 include, but are not limited to, those presented in U.S. Patent Application Publication No. US 2013/0035982 A1, U.S. patent application Ser. No. 13/368,515 to Zhang et al., the contents of which are hereby incorporated by reference and U.S. Patent Application Publication No. US 2013/0073374 A1. U.S. patent application Ser. No. 13/233,352 Heath, the contents of which are also hereby incorporated by reference.

In addition to scraping the user's social media web pages, the social media scrape module 108 may scrape data from the social media web pages of friends of the user and store it on the social media scrape database 114. Such friends may be identified by the social media scrape module using data from the user information database 106 (such as a list of friends) or from the user's social media web pages (for example, “friends” on Facebook).

The data obtained by the social media scrape performed by the social media scrape module 108 is stored on social media scrape database 114, with the user identifier as the key. The social media scrape module 108 regularly scrapes information available on the user's pages on the social media websites 112 so that current information for the information is stored on the media scrape database 114.

The location module 104 also has access to a personal image capture database 110 upon which the location module stores images of locations frequently viewed by the user which. As a result, pattern data in terms of images of locations, businesses, etc. frequently visited by the user are stored on the personal image capture database 110 for access by the location module 104. Businesses and locations frequently visited by the user, for example, may be considered the same as the user liking such businesses and locations or having an interest in the subject matter of such businesses and locations. For example, if the user frequently visits an Italian restaurant, the pattern may indicate that the user likes Italian cuisine.

As described previously, with reference to block 98 of FIG. 2, the location and viewing angle in the form of vector V and the view received by the user via the image capture device at are passed from the augmented reality device to the location module (104 of FIG. 4) of the server. This data is used to determine what the user is looking at as follows.

As indicated by block 120 of FIG. 2. the location module compares the user view (from the image capture device 14 of FIG. 1) with a street level mapping database to determine what the user is viewing. More specifically, with reference to FIG. 4, the location module 104 communicates through network 92 with a street level mapping database 122. The location module 104 compares the user view with images on the street level mapping database 122. When there is a match, the location of the user, and what the user is looking at, may be determined from the street level mapping database.

As an alternative, the location module may use the technology of U.S. Patent Application. Publication No. US 2012/0310968 A1, U.S. patent application Ser. No. 13/118,926 to Tseng, the contents of which are hereby incorporated by reference, to identify the location based on the viewed objects.

Alternatively, or as a backup, the location module uses the OPS location and viewing angle (vector V) to determine the user location and what the user is looking at. If the users location and what the user is looking at cannot be determined using the street level mapping database or the GPS position and vector V, the location module searches for matches in the personal image capture database 110, the social media scrape database 108 and an the social media websites 112 via the social media scrape module. Alternatively, or in addition to the social media websites 112, the location module may use the social media scrape module to search the Internet in general for images that match the user's view so that the user's location and what the user is viewing, may be determined.

As another alternative, the location module 104 may identify the business being viewed by the user through use of the technology disclosed in U.S. Pat. No, 8,379,912 to Yadid et al., the contents of which are hereby incorporated by reference.

Once the location module 104 of FIG. 4 determines where the user is and what the user is looking at, the social media scrape database and personal image capture database are accessed to determine if there is some connection between the user and the location or business being viewed (block 126 of FIG. 2). For example, a user may have lots of information on her social media websites regarding bowling. The user mentions that she is a member of a bowling league on her social medial website, posts photos on the website, posts howling scores on her website, etc. Such a connection exists if the user is viewing a bowling alley. As another example. a user may be viewing an auto parts store, and posts frequently on his social media websites about his classic muscle car. The system identities such connections, which are opportunities for targeted advertising. As still another example, the user walks past and views a restaurant. A friend of the user has recently mentioned liking it in her social media. The location module 104 identifies a connection and advertising opportunity between that business and the user.

A user may also view an object or person that has a connection with the social media scrape database. Such objects or persons are identified by comparing the user's view (from the user device 8) with photographs stored on the social media scrape database 114 or the personal image capture database 110. For example, the user frequently looks at PORSCHE automobiles as they drive by. A pattern is established on the personal image capture database that indicates that the user is interested in PORSCHE automobiles. As a result, the location module 104 identifies a connection and advertising opportunity when the user's view includes a PORSCHE automobile. As another example, a user views a friend coming out of a business. The location module 104 identifies a connection and advertising opportunity between that business and the user (the friend has gone there and possibly likes it).

As examples only, the location module may use the technology of U.S. Pat. No. 8,341,145 to Dodson et al., the contents of which are hereby incorporated by reference, to recognize the faces of friends of the user, while the technology disclosed in U.S. Patent Application Publication No. US 2012/0310968 A1, U.S. patent application Ser. No. 13/118,926 to Tseng, may be used to identify viewed objects.

With reference to FIG. 4, if there is a connection between the user and the location, business and/or object being viewed, determined as described above, a targeted advertisement generator engine 130 is used to identify and display relevant advertisements to the user (block 131 of FIG. 2). More specifically, the targeted ad generator 130 communicates with an advertising database 132, upon which advertisements are stored. The advertisements are indexed by the location, business and/or object names or other identifiers. The name or other identifier of the location, business and/or object being viewed, and having a connection with the user, is used by the targeted ad generator 130 to pull corresponding, relevant ads from the advertising database 132. For example, a connection has been established between a restaurant that the user is viewing and the user (because, using an example from above, a friend of the user indicates she likes the restaurant on her social media). The targeted advertisement generator 130 would retrieve an advertisement for that restaurant from the advertising database, if any such advertisements are present on the advertising database. Continuing with another example from above, the user is viewing a PORSCHE automobile, where a connection has been made between the user and PORSCHE automobiles. If there are any advertisements for PORSCHE automobiles on the advertising database 132, such advertisements would be retrieved by the targeted ad generator.

The advertising database 132 of FIG. 4 may contain “template” style advertisements where information from the social media scrape database 114 or personal image capture database 110 may be inserted by the targeted ad generator to create more personalized advertisements. As a result, the connection information for a viewed location, business and/or object that caused the advertisement to be retrieved may be used in the advertisement. For example, continuing with an example from above, where a user's friend likes a restaurant viewed by the user, the targeted ad generator could retrieve a template advertisement from the advertising database and insert the friend's name to generate an advertisement such as “Suzy really likes (restaurant name)”.

In an alternative embodiment, the targeted ad generator may display the raw social media data that creates the connection between the user and the location, business and/or object. For example, a friend of the user may tweet “I am at Bill's Tavern,” which will be displayed on the display of the user's augmented reality device as described below. Such information may be displayed in addition to any advertisements on the advertising database 132 for the location, business or object. Alternatively, the information may be displayed even if no such advertisements exist on the advertising database for the location, business or object.

If multiple objects and/or businesses for which there exists connections are being viewed by the user, the targeted ad generator may pull a number of corresponding, relevant advertisements from the advertising database.

The system is constantly identifying the location and view of the user, whether there are any connections and constantly checking if the system has any corresponding, relevant advertisers or advertisements.

One the targeted advertisements have been generated by the targeted ad generator, they are displayed as banners or textual overlays on the user's augmented reality device (see block 134 of FIG. 2). With reference to FIG. 4, this is accomplished using an image rendering engine 136 which communicates with the user device 8 through network 92. The image rendering engine translates the advertisements from two-dimensional coordinates (such as a JPEG format picture) of the image as stored on the advertising database 132 to three-dimensional coordinates for the display (12 of FIG. 1) of the augmented reality device 8. This may be accomplished, as an example only, using the technology of U.S. Patent Application Publication No. US 2009/0237328 A1, U.S. patent application Ser. No. 12/051,969 to Gyorfi et al., the contents of which are hereby incorporated by reference.

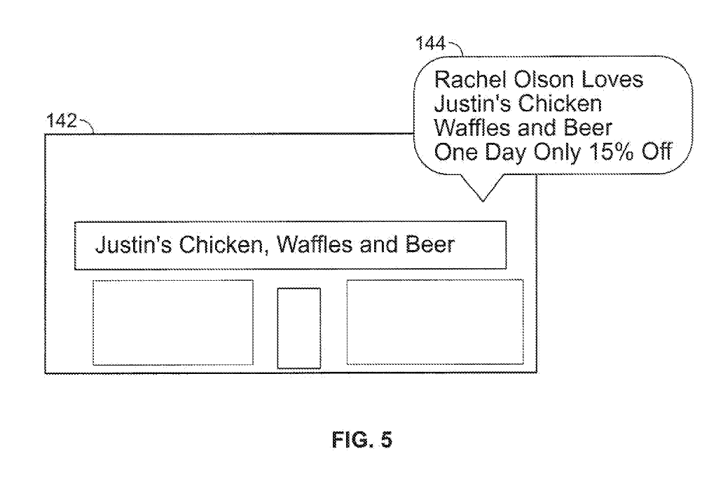

A simplified example of a display presented to a user of the augmented reality device (8 of FIGS. 1 and 4) is presented in FIG. 5. In this example, the user is viewing a business 142 (FIGS. 4 and 5), which is “Justin's Chicken, Waffles and Beer.” A connection exists in that the user's friend, Rachael Olson, has indicated on her social media web pages that she likes the restaurant. The targeted ad generator (130 of Fig, 4) retrieves as template advertisement from the advertising database (132 of FIG. 4) and inserts Rachael's name. In addition, the advertising database contains an advertisement for the restaurant indicating a special for that day only of 18% off. As a result, in addition to the real-time view of the restaurant 142 on the display (12 of FIG. 1) of the augmented reality device, the user sees advertising banner 144 (FIG. 5). The banner 144 is essentially a superimposed image of a large sign which appears over the location, business or object and may explain the connection to the user, and display any advertisements or other information for the location, business or object.

While the preferred embodiments of the invention have been shown and described, it will be apparent to those skilled in the art that changes and modifications may be made therein without departing from the spirit of the invention, the scope of which is defined by the appended claims.

What is claimed is:

1. A system for advertising on an augmented reality to a user comprising:
a) a processing device adapted to communicate with the augmented reality device and a network;
b) a media scrape database in communication with the processing device;
c) an advertising database in communication with the processing device, said advertising database having advertising data stored thereon;
d) said processing device programmed to:
i. receive an image from the augmented reality device;
ii. scrape social media data relating to the user stored on the network;
iii. store the scraped social media data on the media scrape database;
iv. compare the image to the scraped social media data to determine if there is a connection between the user and the image;
v. compare the image to the advertising data if there is a connection between the user and the image;
vi. generate an advertisement using advertising data corresponding to the image;
vii. transmit the advertisement to the augmented reality device for viewing by the user.

2. The system of claim 1 further comprising a personal image capture database in communication with the processing device and adapted to receive images and store images from the augmented reality device, and said processing device further programmed to identify repeated view patterns in the images stored in the personal image capture database.

3. The system of claim 1 wherein the processing device is adapted to receive location data from the augmented reality device and wherein the processing device is further programmed to identify a location of the user from the location data.

4. The system of claim 3 wherein the location data is global positioning system data

5. The system of claim 1 wherein the processing device is adapted to communicate with a street mapping database and the processing device is programmed to identify the users location by comparing images received from the augmented viewing device with images on the street mapping database.

6. The system of claim 1 wherein the processing device is programmed to identify objects in the image received from the augmented viewing device and identify the location of the user based on the objects.

7. The system of claim 1 wherein the processing device is programmed to create advertisements using the scraped social media data.

8. The system of claim 1 wherein the advertising data includes advertisement templates and the processing device is programmed to create advertisements using the advertisement templates and the scraped social media data.

9. The system of claim 1 further comprising a user information database in communication with the processing device and storing login information for user to access the processing device and login information for accessing the user's social media data stored on the network.

10. The system of claim 9 wherein the user information database also stores personal information about the user including the names of friends.

11. The system of claim 1 wherein the processing device is further programmed to convert the advertisement from a two-dimensional storage format to a three-dimensional display format.

12. The system of claim 1 wherein the media scrape database and the advertising database are stored on the processing device.

13. The system of claim 1 wherein the network is the Internet.

14. A system for advertising in augmented reality to a user comprising:
a) an augmented reality device;
b) a processing device in communication with the augmented reality device and adapted to communicate with a network;
b) a media scrape database in communication with the processing device;
c) an advertising database in communication with the processing device, said advertising database having advertising data stored thereon;
d) said processing device programmed to:
i. receive an image from the augmented reality device;
ii. scrape social media data relating to the user stored on the network;
iii. store the scraped social media data on the media scrape database;
iv. compare the image to the scraped social media data to determine if there is a connection between the user and the image;
v. compare the image to the advertising data if there is a connection between the user and the image;
vi. generate an advertisement using advertising data corresponding to the image;
vii. transmit the advertisement to the augmented reality device for viewing by the user.

15. The system of claim 14 further comprising a personal image capture database in communication with the processing device, said personal image capture database receiving images and storing images from the augmented reality device, and said processing device further programmed to identify repeated view patterns in the images stored in the personal image capture database.

16. The system of claim 14 wherein the processing device receives location data from the augmented reality device and wherein the processing device is further programmed to identify a location of the user from the location data.

17. The system of claim 16 wherein the location data is global positioning system data.

18. The system of claim 14 wherein the processing device is adapted to communicate with a street mapping database and the processing device is programmed to identify the users location by comparing images received from the augmented viewing device with images on the street mapping database.

19. The system of claim 14 wherein the processing device is programmed to identify objects in the image received from the augmented viewing device and identify the location of the user based on the objects.

20. The system of claim 14 wherein the processing device is programmed to create advertisements using the scraped social media data.

21. The system of claim 14 wherein the advertising data includes advertisement templates and the processing device is programmed to create advertisements using the advertisement templates and the scraped social media data.

22. The system of claim 14 further comprising a user information database in communication with the processing device and storing login information for the user to access the processing device and login information for accessing the user's social media data stored on the network,

23. The system of claim 22 wherein the user information database also stores personal information about the user including the names of friends.

24. The system of claim 14 wherein the processing device is farther programmed to convert the advertisement from a two-dimensional storage format to a three-dimensional display format.

25. The system of claim 14 wherein the media serape database and the advertising database are stored on the processing device.

26. The system of claim 14 wherein the network is the Internet.

27. The system of claim 14 wherein the augmented reality device calculates a vector corresponding to the user's view and the processing device is programmed to identify what the user is looking at based on the vector.

28. The system of claim 14 wherein the augmented reality device includes an accelerometer and transmits accelerometer data to the processing device and the processing device is programmed to determine a viewing angle of the user from the accelerometer data.

29. The system of claim 14 wherein the augmented reality device includes a magnetometer and transmits magnetometer data to the processing device for use in determining a viewing angle of the user from the accelerometer data.

30. A method for advertising in augmented reality to a user comprising the steps of:
a) providing an augmented reality device, a processing device in communication with the augmented reality device, a media scrape database in communication with the processing device and an advertising database in communication with the processing device;
b) storing advertising data on the advertising database;
c) receiving an image from the augmented reality device;
d) scraping social media data relating to the user stored on the network;
e) storing the scraped social media data on the media serape database;
f) comparing the image to the scraped social media data to determine if there is a connection between the user and the image;
g) comparing the image to the advertising data if there is a connection between the user and the image;
h) generating an advertisement using advertising data corresponding to the image; and
i) transmitting the advertisement to the augmented reality device for viewing. by the user.

31. The method of claim 30 further comprising the step of:
j) converting the advertisement of step h) from a two-dimensional storage format to a three-dimensional display format prior to step i).

32. The method of claim 30 wherein the network is the Internet.

33. The method of claim 30 further comprising the steps of storing images from the augmented reality device and identifying repeated view patterns in the images stored in the personal image capture database.

34. The method of claim 30 further comprising the steps of receiving location data from the augmented reality device and identifying a location of the user from the location data.

35. The method of claim 34 wherein the location data is global positioning system data.

36. The method of claim 30 further comprising the steps of receiving street mapping images and identifying the users location by comparing, images received from the augmented viewing device with the street mapping images.

37. The method of claim 30 further comprising the steps of identifying objects in the image received from the augmented viewing device and identify the location of the user based on the objects.

38. The method of claim 30 further comprising the step of creating advertisements using the scraped social media data.
